(19) United States
(12) Patent Application Publication
(10) Pub. No.: US 2006/0138689 A1
(43) Pub. Date: Jun. 29, 2006

(54) Apparatus and method for compression molding a chair mat

(76) Inventors: John N. Endrud, Rockford, IL (US); Larry D. Weber, Akron, OH (US)

Correspondence Address: DAVID J. ARCHER, 7037 POMERY ROAD, ROCKTON, IL, 61072, US

(21) Appl. No.: 11/025,533

(22) Filed: Dec. 29, 2004

(51) Int. Cl. B29C 43/02

(52) U.S. Cl. 264/40.4; 264/319; 425/395

(57) ABSTRACT

An apparatus is disclosed for compression molding a chair mat. The apparatus includes an extruder for extruding a quantity of accurately weighed melted polymer. A polymer transfer tray is disposed adjacent to the extruder for receiving the quantity of accurately weighed melted polymer thereon. A forming press is disposed downstream from the extruder for compression molding the quantity of accurately weighed melted polymer. A conveyor is provided for moving the polymer transfer tray with the quantity of melted polymer thereon from the extruder to the press. The forming press includes a first mold for molding an upper impression of the chair mat. A second mold is provided for molding a lower impression of the chair mat. The first and second molds are movable relative to each other from an open disposition thereof for permitting loading of the quantity of accurately weighed melted polymer between the molds to a closed disposition of the molds in which the molds are moved towards each other for compression molding the quantity of weighed melted polymer between the molds.

### BACKGROUND OF THE INVENTION

1. Field of the Invention

The present invention relates to an apparatus and method for molding a chair mat. More specifically, the present invention relates to an apparatus and method for compression molding a chair mat.

2. Background Information

The development of relatively low cost synthetic polymers such as nylon and polyester made the production of office carpet economically viable. Prior to such development, only a few executive offices had carpeting. However, with the development of such synthetic polymers, the need to have a hard surface for chair casters to roll on became imperative. Consequently, there was a need for a chair mat that was aesthetically pleasing and that would allow the carpet to be seen. Acrylic was the only viable material during the early stages of the development of chair mats. Initially, such chair mats were cell cast and later were manufactured by a continuous cast process. Acrylic sheets for chair mats were first produced by the cell cast method and later by a continuous cast process, whereby methyl methacrylate liquid monomer was polymerized directly into a sheet. These processes require very large capital investment. The cast sheets were sold to fabricators who would “router” the shape and impart a beveled edge to the resultant chair mat to reduce sharpness.

Subsequently, the production of Lexan polycarbonate sheets for glazing, signs and many other applications were being produced for a market that had historically been dominated by acrylics. Although the production of chair mats using polycarbonate was a logical extension, such polycarbonate was much more expensive on a pound basis, so there was a need to make the chair mat thinner. Also there was a need to fabricate the finished product and to market directly to large consumers and office supply companies. Although a lifetime warranty was offered against breakage, such polycarbonate chair mats did not perform as anticipated.

Additionally, experimentation with the extrusion of polycarbonate sheets was made but did not pose a serious threat to the production of acrylic chair mats. More specifically, polycarbonate resin was used to extrude sheet through a die into a roll forming station where the embossed or polished finished surface was formed. This station also functioned as a cooling point.

Flexible plasticized polyvinyl chloride (PVC) had been used to make carpet runners for high traffic areas. These carpet runners typically had “grippers” to keep the “runners” from sliding on the carpet, a problem that had plagued acrylic and polycarbonate chair mats. Another problem with such prior art chair mats was the tendency for the edges to warp upwardly, presenting a potential “tripping” hazard. Therefore, the manufactures of such chair mats would instruct users to rotate the chair mat periodically, turning the top over. With carpet runners, the PVC was a softer product and would lay flat and combined with the grippers, would stay in place. Consequently, manufactures of carpet runners developed the technique of extruding finished chair mats from PVC. The use of the softer PVC permitted the production of a chair mat having half the thickness of the corresponding acrylic chair mats. More particularly, PVC resin is mixed with stabilizers, plasticizers and other additives to achieve the desired softness. This mix (called a compound) in a powder form or pellet form, is extruded in much the same manner as polycarbonate (single screw extruder) or with multiple screw extruders for powder compounds. Two significant improvements in the process are: (1) the coextrusion of a softer strip in the center allowing the mat to be folded and (2) the design of the mat is engraved onto one of the rolls in the forming station, which gives a polished beveled edge versus one that is mechanically (router) produced.

All the aforementioned prior art plastic chair mats have have been produced via the cast or extrusion process.

U.S. Pat. No. 5,073,428 to Lancelot et al teaches the production of a foldable floor mat. Also, U.S. Pat. No. 5,048,182 describes the production of a chair mat using counter rotating rolls.

In the apparatus and method according to the present invention, a single or multiple screw extruder is used similar to the extruders used for extruding polycarbonate and PVC for the prior art chair mats, however no sheet forming die or roll forming station is used. Rather, “lumps” of accurately weighed melted thermoplastic polymer (starting with, but not limited to PVC) is extruded onto polymer transfer trays which are conveyed to forming presses where the top finish and bottom finish with grippers are produced. The ability to form a finished shape without the need to trim large amounts of excess results in significant labor, re-work, scrap and raw material reduction.

Therefore, it is a primary feature of the present invention to provide an apparatus for compression molding a chair mat that overcomes the problems associated with the prior art arrangements.

Another feature of the present invention is the provision of an apparatus for compression molding a chair mat that greatly reduces the production cost of chair mats.

A further feature of the present invention is the provision of an apparatus for compression molding a chair mat that reduces the amount of waste material generated during the production of chair mats.

Other features and advantages of the present invention will be readily apparent to those skilled in the art by a consideration of the detailed description of a preferred embodiment of the present invention contained herein.

### SUMMARY OF THE INVENTION

The present invention relates to an apparatus for compression molding a chair mat. The apparatus includes an extruder for extruding a quantity of accurately weighed melted polymer. A polymer transfer tray is disposed adjacent to the extruder for receiving the quantity of accurately weighed melted polymer thereon. A forming press is disposed downstream from the extruder for compression molding the quantity of accurately weighed melted polymer. A conveyor is provided for moving the polymer transfer tray with the quantity of melted polymer thereon from the extruder to the press. The forming press includes a first mold for molding an upper impression of the chair mat. A second mold is provided for molding a lower impression of the chair mat. The first and second molds are movable relative to each other from an open disposition thereof for permitting loading of the quantity of accurately weighed melted polymer between the molds to a closed disposition of the molds in which the molds are moved towards each other for compression molding the weighed melted polymer between the molds.

In a more specific embodiment of the present invention the extruder includes a housing which has an upstream and a downstream end. The housing defines a chamber having a first and a second end. The first end of the chamber is disposed adjacent to the upstream end of the housing. An electric motor or hydraulic source drives a screw device that is rotatably disposed within the chamber and a hopper is disposed adjacent to the first end of the chamber. The arrangement is such that when the polymer is deposited within the hopper, the polymer is fed from the hopper through the first end of the chamber towards the second end of the chamber due to rotation of the screw device within the chamber so that the polymer flows from the chamber towards the downstream end of the housing.

Those skilled in the art will appreciate that a variety of extruder screw configurations may be employed as the reduced back pressure allows for more intensive mixing without the need for the pressure building required of a sheet die. Further, the extruder horsepower requirement is lessened by this reduced melt pressure requirement. Additionally, the reduction in pressure building reduces the degradation of thermally sensitive polymers such as PVC.

The apparatus further includes a weighing device which is disposed adjacent to the downstream end of the housing for accurately weighing the quantity of extruded polymer so that the weighing device meters the quantity of extruded polymer deposited on the polymer transfer tray.

Additionally, the polymer transfer tray includes a planar portion of generally rectangular configuration, the planar portion defining a peripheral edge. A ridge extends upwardly from the peripheral edge of the planar portion for containing the quantity of accurately weighed melted polymer when deposited on the polymer transfer tray.

Furthermore, the forming press is a hydraulic forming press. Alternatively, the press can be a pneumatically, electro/mechanically or other energy transfer forming press.

Also, the conveyor includes a robotic transfer arm. The arrangement is such that the conveyor moves the polymer transfer tray with the polymer thereon from the extruder to the forming press.

Moreover, the apparatus further includes a device for removing the polymer from the polymer transfer tray when the polymer transfer tray is disposed adjacent to or at the forming press such that the polymer is placed within the forming press between the two molds within the forming press.

Additionally, the first mold includes a movable platen. The first mold defines the upper impression of the chair mat. A plurality of guides extend from the movable platen to the second mold for guiding the movable platen and the first mold between the open and closed dispositions of the molds. A driving device is provided for moving the movable platen between the open and closed dispositions of the molds. The arrangement is such that when the quantity of accurately weighed polymer is disposed between the molds, the movable platen is urged by the driving device towards the second mold, the guides guiding the first mold into register with the second mold so that the polymer disposed between the first mold and the second mold is compression molded between the molds.

More specifically, the driving device includes a hydraulic, pneumatic, electro/mechanical or other energy device ram for urging the movable platen from the open towards the closed disposition.

Also, the driving device further includes a process control for controlling the ram such that the ram is selectively controlled to move the movable platen from the closed to the open disposition for permitting removal of the molded chair mat from between the molds.

The present invention also includes a method for compression molding a chair mat. The method includes the steps of extruding a quantity of accurately weighed melted polymer through an extruder and receiving the quantity of accurately weighed melted polymer onto a polymer transfer device such as a polymer transfer tray disposed adjacent to the extruder for transfer to the forming press.

The method also includes conveying the polymer transfer tray with the quantity of melted polymer thereon from the extruder to a forming press and moving a first and a second mold of the press relative to each other from an open disposition of the molds for permitting loading of the quantity of accurately weighed melted polymer between the molds. The molds are moved to a closed disposition for compression molding the quantity of weighed melted polymer between the molds.

Throughout the disclosure of the present invention, the term “conveyor” is to be construed as including preferably, a robot transfer arm but also in the alternative, a conventional conveyor or any other suitable material handling device. Also, throughout the disclosure of the present invention, it will be understood by those skilled in the art that with regard to the extruder, the term “a screw device” includes not only a single screw device but also a multiple screw device.

Furthermore, it is to be understood by those skilled in the art that, in the disclosure of the present invention, with regard to the press, the power source thereof in an alternative arrangement would be pneumatic, electro/mechanical or any other suitable energy device.

Accordingly, many modifications and variations of the present invention will be readily apparent to those skilled in the art by a consideration of the detailed description contained hereinafter taken in conjunction with the annexed drawings which show a preferred embodiment of the present invention. However, such modifications and variations fall within the spirit and scope of the present invention as defined by the appended claims.

### BRIEF DESCRIPTION OF THE DRAWINGS

FIG. 1 is a side elevational view of an apparatus according to the present invention for compression molding a chair mat; and

FIG. 2 is a similar view to that shown in FIG. 1. but shows the molds in a closed disposition.

Similar reference characters refer to similar parts throughout the various views of the drawings.

### DETAILED DESCRIPTION OF THE DRAWINGS

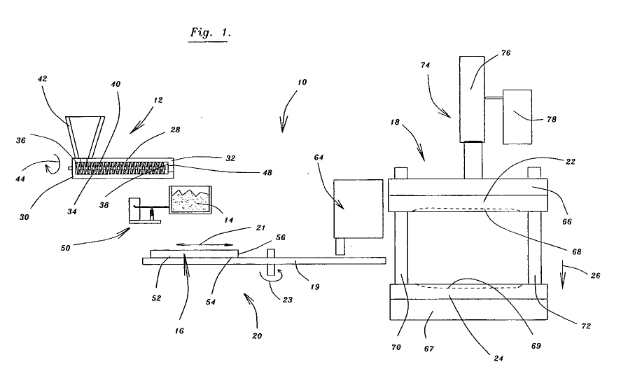

FIG. 1 is a side elevational view of an apparatus generally designated 10 for compression molding a chair mat. As shown in FIG. 1, the apparatus 10 includes an extruder generally designated 12 for extruding a quantity 14 of accurately weighed melted polymer. A polymer transfer tray generally designated 16 is disposed adjacent to the extruder 12 for receiving the quantity 14 of accurately weighed melted polymer thereon. A forming press generally designated 18 is disposed downstream from the extruder 12 for compression molding the quantity 14 of accurately weighed melted polymer. A conveyor generally designated 20 such as a rotatable robot transfer arm 19, is provided for moving the polymer transfer tray 16 as indicated by the arrow 21 with the quantity 14 of melted polymer thereon from the extruder 12 to the press 18. The forming press 18 includes a first mold 22 for molding an upper impression of the chair mat. A second mold 24 is provided for molding a lower impression of the chair mat. The first and second molds 22 and 24 are movable relative to each other as indicated by the arrow 26 from an open disposition thereof as shown in FIG. 1 for permitting loading of the quantity 14 of accurately weighed melted polymer between the molds 22 and 24. Also, it will be understood by those skilled in the art that the present invention includes an arrangement in which multiple polymer transfer trays could be shuttled in and out under the extruder discharge and would be picked by the conveyor robot arm for delivery to the appropriate press if more than one press is provided.

The extruder 12 includes an extruder screw or screws housed in a barrel or housing. The configuration of the screws may be varied to give the optimum level of mixing and temperature. The screws are driven by an electric or hydraulic source through a gear reduction unit to provide the necessary torque to rotate the screw or screws. More particularly, the screw or multiple screws are secured to a feed section that is affixed to the gear reducer that also houses a thrust bearing. The discharge end of the barrel has an adapter 48 to give a specific shape/volume output. Prior to the adapter, a screen changer to screen out impurities may be employed.

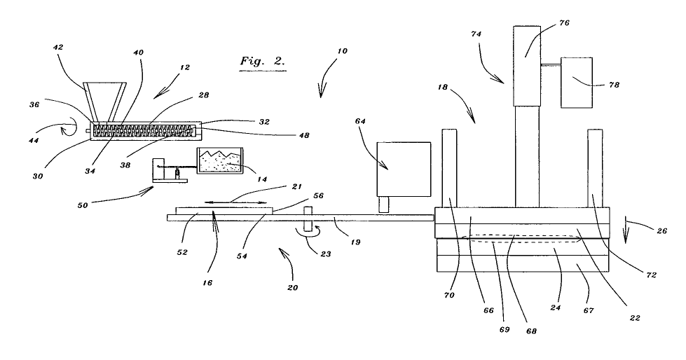

FIG. 2 is a similar view to that shown in FIG. 1. However, as shown in FIG. 2, the molds 22 and 24 are shown having moved as indicated by the arrow 26 to a closed disposition of the molds 22 and 24 for compression molding the quantity 14 of the weighed melted polymer between the molds 22 and 24.

As shown in FIGS. 1 and 2, the extruder 12 includes a housing 28 which has an upstream and a downstream end 30 and 32 respectively. The housing 28 defines a chamber 34 having a first and a second end 36 and 38 respectively. The first end 36 of the chamber 34 is disposed adjacent to the upstream end 30 of the housing 28. A screw device 40 is rotatably disposed within the chamber 34 and a hopper 42 is disposed adjacent to the first end 36 of the chamber 34. The arrangement is such that when the polymer is deposited within the hopper 42, the polymer is fed from the hopper 42 through the first end 36 of the chamber 34 towards the second end 38 of the chamber 34 due to rotation as indicated by the arrow 44 of the screw device 40 within the chamber 34. The housing 28 also includes an adapter 48 to give a uniform discharge onto the polymer transfer tray 16. The extruder screw is configured to provide the amount of mixing and heat required to give the best forming results.

As shown in FIGS. 1 and 2, the apparatus further includes a weighing device generally designated 50 which is disposed adjacent to the downstream end 32 of the housing 28 for accurately weighing the quantity 14 of extruded polymer so that the weighing device 50 meters the quantity of extruded polymer deposited on the polymer transfer tray 16.

Additionally, as shown in FIGS. 1 and 2, the polymer transfer tray 16 includes a planar portion 52 of generally rectangular configuration, the planar portion 52 defining a peripheral edge 54. A ridge 56 extends upwardly from the peripheral edge 54 of the planar portion 52 for containing the quantity 14 of accurately weighed melted polymer when deposited on the polymer transfer tray 16.

Furthermore, as shown in FIGS. 1 and 2, the forming press 18 is a hydraulic forming press.

Also, as shown in FIGS. 1 and 2, the conveyor 20 includes a robot transfer arm 19 for moving the polymer transfer tray 16 as indicated by the arrow 21 with the polymer thereon from the extruder 12 to the forming press 18. The robot transfer arm 19 rotates through 180 degrees as indicated by the arrow 23 for transferring the polymer transfer tray 16 to the press 18. Alternatively, the robot transfer arm 19 would include means for picking up the polymer transfer tray 16 and then moving the polymer transfer tray to the press 18. The robot transfer arm 19 would also include a push mechanism 64 for sliding the polymer off the polymer transfer tray 16.

Moreover, the apparatus 10 includes the push mechanism device generally designated 64 for removing the quantity 14 of polymer from the polymer transfer tray 16 when the polymer transfer tray 16 is disposed adjacent to the forming press 18 such that the quantity 14 of polymer is placed within the forming press 18.

Additionally, the first mold 22 includes a movable platen 66. The first mold 22 defines an upper impression 68 of the chair mat. A plurality of guides 70 and 72 extend from the movable platen 66 to the second mold 24 for guiding the movable platen 66 and the first mold 22 between the open and closed dispositions of the molds 22 and 24 as shown in FIG. 1 and FIG. 2 respectively. A driving device generally designated 74 is provided for moving the movable platen 66 between the open disposition as shown in FIG. 1 and the closed disposition of the molds 22 and 24 as shown in FIG. 2. The arrangement is such that when the quantity 14 of accurately weighed polymer is disposed between the molds 22 and 24, the movable platen 66 is urged by the driving device 74 towards the second mold 24 as indicated by the arrow 26, the guides 70 and 72 guiding the first mold 22 into register with the second mold 24 so that the quantity 14 of polymer disposed between the first mold 22 and the second mold 24 is compression molded between the molds 22 and 24.

Additionally, the second mold 24, as shown in FIGS. 1 and 2, includes a nonmovable lower platen 67 and the second mold 24 includes a lower impression 69 of the chair mat.

More specifically, the driving device 74 includes a hydraulic ram 76 for urging the movable platen 66 from the open disposition as shown in FIG. 1 towards the closed disposition shown in FIG. 2.

Also, the driving device 74 further includes a control 78 for controlling the ram 76 such that the ram 76 is selectively controlled to move the movable platen 66 from the closed disposition shown in FIG. 2 to the open disposition shown in FIG. 1 for permitting removal of the molded chair mat from between the molds 22 and 24.

In operation of the apparatus 10 according to the present invention a chair mat is compression molded by extruding a quantity 14 of accurately weighed melted polymer through an extruder 12. The accurately weighed quantity 14 is received onto the polymer transfer tray 16 disposed adjacent the extruder 12. The quantity 14 of polymer is compression molded in the forming press 18 which is disposed downstream from the extruder 12. The polymer transfer tray is conveyed with the quantity of melted polymer thereon from the extruder 12 to the press 18. The molds 22 and 24 are moved relative to each other from the open disposition of the molds as shown in FIG. 1 for permitting loading of the quantity 14 of accurately weighed melted polymer between the molds 22 and 24 to the closed disposition of the molds as shown in FIG. 2 in which the molds 22 and 24 are moved towards each other for compression molding the quantity 14 of weighed melted polymer between the molds.

The present invention provides a unique apparatus for compression molding chair mats which greatly reduces the amount of material needed to fabricate a chair mat.

What is claimed is:

1. An apparatus for compression molding a chair mat, said apparatus comprising:
an extruder for extruding a quantity of accurately weighed melted polymer;
a polymer transfer tray disposed adjacent to said extruder for receiving said quantity of accurately weighed melted polymer thereon;
a forming press disposed downstream from said extruder for compression molding said quantity of accurately weighed melted polymer;
a conveyor for moving said polymer transfer tray with said quantity of melted polymer thereon from said extruder to said press;
said forming press including:
a first mold for molding an upper impression of the chair mat; and
a second mold for molding a lower impression of the chair mat, said first and second molds being movable relative to each other from an open disposition thereof for permitting loading of said quantity of accurately weighed melted polymer between said molds to a closed disposition of said molds in which said molds are moved towards each other for compression molding said quantity of weighed melted polymer between said molds.

2. An apparatus for compression molding a chair mat as set forth in claim 1 wherein said extruder includes:
a housing having an upstream and a downstream end, said housing defining a chamber having a first and a second end, said first end of said chamber being disposed adjacent to said upstream end of said housing;
a screw device rotatably disposed within said chamber;
a hopper disposed adjacent to said first end of said chamber such that when said polymer is deposited within said hopper, said polymer is fed from said hopper through said first end of said chamber towards said second end of said chamber due to rotation of said screw device within said chamber.

3. An apparatus for compression molding a chair mat as set forth in claim 2
said apparatus further including:
a weighing device disposed adjacent to said downstream end of said housing for accurately weighing said quantity of extruded polymer so that said weighing device meters said quantity of extruded polymer deposited on said polymer transfer tray.

4. An apparatus for compression molding a chair mat as set forth in claim 1 wherein
said polymer transfer tray includes:
a planar portion of generally rectangular configuration, said planar portion defining a peripheral edge;
a ridge extending upwardly from said peripheral edge of said planar portion for containing said quantity of accurately weighed melted polymer when deposited on said polymer transfer tray.

5. An apparatus for compression molding a chair mat as set forth in claim 1 wherein
said forming press is a compression forming press.

6. An apparatus for compression molding a chair mat as set forth in claim 1 wherein
said conveyor includes:
a robot transfer arm for moving said polymer transfer tray with said polymer thereon from said extruder to said forming press.

7. An apparatus for compression molding a chair mat as set forth in claim 1
said apparatus further includes:
a device for removing said quantity of polymer from said polymer transfer tray disposed adjacent to said forming press such that said quantity of polymer is placed within said forming press.

8. An apparatus for compression molding a chair mat as set forth in claim 1 wherein said first mold includes:
a movable platen;
said first mold defining said upper impression of the chair mat;
a plurality of guides extending from said movable platen to said second mold for guiding said movable platen and said first mold between said open and said closed dispositions of said molds;
a driving device for moving said movable platen and said first mold between said open and said closed dispositions of said molds such that when said quantity of accurately weighed polymer is disposed between said molds, said movable platen is urged by said driving device towards said second mold, said guides guiding said first mold into register with said second mold so that said quantity of polymer disposed between said first mold and said second mold is compression molded between said molds.

9. An apparatus for compression molding a chair mat as set forth in claim 8 wherein
said driving device includes:
a ram for urging said movable platen from said open towards said closed disposition.

10. An apparatus for compression molding a chair mat as set forth in claim 9 wherein
said driving device further includes:
a control for controlling said ram such that said ram is selectively controlled to move said movable platen from said closed to said open disposition for permitting removal of said molded chair mat from between said molds.

11. An apparatus for compression molding a chair mat, said apparatus comprising:
an extruder for extruding a quantity of accurately weighed melted polymer;
a polymer transfer tray disposed adjacent said extruder for receiving said quantity of accurately weighed melted polymer thereon;
a forming press disposed downstream from said extruder for compression molding said quantity of accurately weighed melted polymer;
a conveyor for moving said polymer transfer tray with said quantity of melted polymer thereon from said extruder to said press;
said forming press including:
a first mold for molding an upper impression of the chair mat;
a second mold for molding a lower impression of the chair mat, said first and second molds being movable relative to each other from an open disposition thereof for permitting loading of said quantity of accurately weighed melted polymer between said molds to a closed disposition of said molds in which said molds are moved towards each other for compression molding said quantity of weighed melted polymer between said molds;
said first mold including:
a movable platen;
said first mold defining said upper impression of the chair mat;
a plurality of guides extending from said movable platen to said second mold for guiding said movable platen and said first mold between said open and closed dispositions of said molds; and
a ram for moving said movable platen between said open and closed dispositions of said molds such that when said quantity of accurately weighed polymer is disposed between said molds, said movable platen is urged by said ram towards said second mold, said guides guiding said movable platen and said first mold into register with said second mold so that said quantity of polymer disposed between said first mold and said second mold is compression molded between said molds.

12. A method for compression molding a chair mat, said method comprising the steps of:
extruding a quantity of accurately weighed melted polymer through an extruder;
receiving the quantity of accurately weighed melted polymer onto a polymer transfer tray disposed adjacent to the extruder;
conveying the polymer transfer tray with the quantity of melted polymer thereon from the extruder to a forming press; and
moving a first and a second mold of the press relative to each other from an open disposition of the molds for permitting loading of the quantity of accurately weighed melted polymer between the molds to a closed disposition of the molds in which the molds are moved towards each other for compression molding the quantity of weighed melted polymer between the molds.
